(19) United States
(12) Patent Application Publication
(10) Pub. No.: US 2026/0085214 A1
(43) Pub. Date: Mar. 26, 2026

(54) ADHESIVES WHICH CAN BE APPLIED ONE-SIDED AND WHICH CAN BE USED FOR ROLL-PACK MATTRESSES

(71) Applicant: STRONGBOND B.V., Dinxperlo (NL)

(72) Inventors: Rudolph Frank DE BLOCK, Dinxperlo (NL); Mees VOS, Dinxperlo (NL); Juan Bernardo Manzano LIEBRAND, Dinxperlo (NL)

(73) Assignee: STRONGBOND B.V., Dinxperlo (NL)

(21) Appl. No.: 19/128,142

(22) PCT Filed: Nov. 9, 2023
(86) PCT No.: PCT/NL2023/050591

§ 371 Date: May 7, 2025

(30) Foreign Application Priority Data
Nov. 9, 2022 (NL) 2033488

(51) Int. Cl. C09J 107/02; C09J 5/00; C09J 11/04; C09J 133/04; C09J 193/04

(52) U.S. Cl. CPC C09J 107/02; C09J 5/00; C09J 11/04; C09J 133/04; C09J 193/04

(57) ABSTRACT

The present invention is in the field of adhesives, in particular based on homopolymers or copolymers of compounds, for use in spray systems, in rollers, or in roll systems, or in roller coaters. These adhesives can be used in layered products characterised by the relation between layers, such as products comprising layers having different or the same physical, chemical or physicochemical properties, such as in foam bonding industry.

### FIELD OF THE INVENTION

The present invention is in the field of water-based adhesives, in particular based on homopolymers or copolymers of compounds, for use in spray applications, in rollers or roll systems. These adhesives can be used in layered products characterised by the relation between layers, such as products comprising layers having different or the same physical, chemical or physicochemical properties, such as in foam bonding industry.

### BACKGROUND OF THE INVENTION

The present invention is in the field of an adhesive, in particular an adhesive that can be applied by spraying, rolling or the like. An adhesive is a material that attaches two parts together. This method is different to using mechanical methods of holding parts together. Adhesives have many advantages and disadvantages compared to mechanical methods of attaching parts. There are natural and synthetic made adhesives available. Most products are either applied in a liquid or paste form which increases in bond strength as it dries. They are used in different applications including manufacturing, construction and repair.

General properties of adhesives are open time (working time to make a bond, where the surface still retains sufficient tack ((initial)degree of surface stickiness of the adhesive), which can range from seconds for fast-setting adhesives to infinity for pressure-sensitive adhesives), built-up time (time to form a bond), set time (time to form a bond of acceptable strength), dry time, (initial) tack, applicability and adhesion to a diverse range of substrate surfaces, contactibility, flexibility of an adhesive film, temperature stability, storage stability, viscosity, and surface energy (influences wetting of different kind of surfaces).

In, for example, the foam bonding industry, the use of so called Rapid Stick Dispersions (RSD) is common. A dispersion is considered to be a physicochemical system in which distributed particles of one material are dispersed in a continuous phase of another material. The two phases may be in the same or different states of matter. Dispersions can be classified in a number of different ways, including how large the particles are in relation to an otherwise (semi-) continuous phase, including the particle size distribution of the dispersed material, whether or not precipitation occurs, and the presence of Brownian motion. These dispersions can be coagulated either by applying an external force, such as for example by a shear force, or by using a second component which is considered to activate the dispersion, such as for example an acid or a multivalent cation. These RSD then show immediate tack, that is, the bond between both substrates to be adhered can be made immediately, resulting in a bond wherein a main body of the water of the adhesive dispersion is still considered to be present. Typical examples thereof are the products Sababond as manufactured by SABA Dinxperlo B.V.

An alternative way of applying such adhesive to the foam is by using a roller system. After application the adhesives may, if desired, be activated using infrared light or other heat source. However, adhesives for this are usually based on not-sustainable raw materials, such as polymers based on fossil carbon sources such as oil and coal.

Incidentally reference can be made to NL2027448B, DE3842344A1, and CN109536080. These documents recite acid sensitive adhesives, which therefore can only be used at specific, basic, pH's. Typically, when provided with an acid, being an activator in those cases, coagulation of the adhesive will occur. NL2027448B recites an adjustable water-based adhesive for a roller or roller system, which may be a one-component adhesive or is a two-component adhesive, a method of applying said adhesive, a product comprising said adhesive, and a use of said adhesive. DE3842344A1 recites an aqueous dispersion of contact adhesive, containing a) NR latex, b) a tackifying resin dispersion, c) a terpene phenolic resin dispersion, and d) conventional auxiliaries such as an emulsifier, antioxidant, stabiliser and/or preservative. CN109536080 recites a water-based environment-friendly roller glue and a preparation method thereof. The environment-friendly roller glue comprises the following components: ammonia-free natural latex or polyisoprene latex, an acrylic emulsion, styrene-butadiene latex, a modified rosin emulsion, a water-based emulsifier, a pH regulating agent, a water-based defoaming agent, a water-based thickening agent and deionized water. Therein, a non-chloroprene system is adopted for preparation, the glue price is lower than the price of roller glue prepared by a chloroprene system, and the problems of high cost, instable supply and the like caused by expensive neoprene latex are avoided. The initial viscosity speed, stability and heat resistance of the mattress roller glue are good, and the roller glue is suitable for bonding materials such as sponge mattresses, leather, non-woven fabrics and the like.

There is therefore a need for improved roller adhesives. It is an object of the present invention to provide an adhesive which overcomes one or more of the above disadvantages, and a method of forming an adhesive, without jeopardizing functionality and advantages.

### SUMMARY OF THE INVENTION

The present adhesive is in particular suited for roller or roller system applications and spray applications. The present adhesives, based on NR-latex, can also be applied one-sided and which can be used for roll-pack mattresses. The present invention relates to an adhesive based on sustainable raw material resources, which is in particular suited for the adhesion of foam to foam or foam to other substrates for e.g. the mattress industry. A raw material considered is natural rubber latex, preferably in the form of a low ammonia latex concentrate, com-monly known as LATZ. However, natural rubber latex has the drawback of the strong ammonia scent and vapour. Also technically, LATZ based adhesives are slower in built-up of strength compared to adhesives based on man-made polymers. As the ammonia is considered to fulfil a crucial role in stabilizing the LATZ and keeping it from coagulation, the ammonia cannot be removed by chemical of physical means without destabilizing the LATZ in such a way it is no longer useful as base material for an adhesive. Finally, todays demanding applications, such as roll-packing of adhesives in which the freshly formed mattress is vacuumized and rolled into a small pack are not met using standard NR-latex based adhesives. Surpris-ingly it has now been found that by the addition of a resin, such as an acidic resin to a LATZ, after which the pH has been adjusted with any base, including ammonia, the resulting adhesive does not have a strong ammonia odour and is in adhesive quality as good or better as common commercial adhesives. Both time to bonding as strength and recovery are improved while being primarily based on sustainable raw materials. Additionally the resin may be added to another dispersion, for example a polyacrylate dispersion to facilitate the production of the adhesive and to strengthen certain aspects of the adhesive. The adhesive assembly tack may be significantly increased by drying the adhesive to air or preferably by heat activation for example with infrared light.

In a first aspect the present invention relates to a water-based adhesive for a roller or roller system comprising a dispersion, the dispersion comprising 5-95 wt. % of an aqueous first dispersion, preferably 10-50 wt. %, more preferably 15-45 wt. %, even more in particular 20-30 wt. %, wherein the first dispersion comprises a natural rubber, in particular wherein the aqueous first dispersion comprises 5-95 wt. % of at least one natural rubber, preferably 10-50 wt. % of at least one natural rubber, more preferably 15-45 wt. % of at least one natural rubber, even more in particular 20-30% wt. % of at least one natural rubber, that is, most or all of the first dispersion comprises the at least one natural rubber, in particular at least one natural latex rubber, more in particular at least one low ammonia latex concentrate, or a cationic stabilized natural latex rubber dispersion, the natural rubber dispersion comprising 30-80 wt. % solids, in particular 45-70 wt. % solids, more in particular 55-65 wt. % solids, and 0-75 wt. % of a second dispersion selected from polychloroprene dispersions, poly-urethane dispersion, poly-acrylate dispersions, styrene-butadiene-styrene copolymer dispersions, nitrile-butadiene rubber dispersions, polyvinyl butyral dispersions, styrene-butadiene rubber dispersions, poly ethylene vinyl acetate dispersions, .poly vinyl acetate dispersions, polyvinyl alcohols, and combinations thereof, in particular a second dispersion selected from a poly-acrylate dispersion, and a polychloroprene dispersion, the second dispersion comprising 30-80 wt. % solids, in particular 35-70 wt. % solids, more in particular 40-60 wt. % solids, further comprising 5-75 wt. % of at least one resin, in particular an acidic resin, preferably 20-60 wt. %, more preferably 25-52 wt. %, even more preferably 33-45 wt. %, further comprising 0.-10 wt. % of at least one surfactant, in particular an anionic surfactant, a non-ionic surfactant, or a cationic surfactant, preferably 0.2-5 wt. %, such as 0.5-2 wt. %, and wherein the dispersion has a pH of 6-11, in particular 6.5-9, more in particular 7.0-8, and further comprising 0-35 wt. % additional water, in particular 2-20 wt. % water, more in particular 5-10 wt. % water, further comprising 0-10 wt. % antifoam, further comprising 0-10 wt. % antioxidant, further comprising 0-1 wt. % biocide, further comprising 0-5 wt. % viscosity modifier, and 0-30 wt. % of a plasticizer and/or oil, wherein all weight percentages are based on a total weight of the adhesive. Compositions that may be considered are LATZ: 5-95 wt. %, preferably 10-50 wt. %, more preferably 15-40 wt. %, like 25 wt. %, Polyacrylate/resin mixture, consisting of, based on final mixture: Polyacrylate dispersion: 0-75 wt. %, preferably 10-50 wt. %, more preferably 15-40 wt. % like 25 wt. %; Glycerol ester of rosin: 5-75 wt. %, preferably 20-60 wt. %, more preferably 45-55 wt. % like 50 wt. %; Polychloroprene dispersion: 0-10 wt. %, Preferably 0-5 wt. %, like 0 wt. %; anionic surfactant: 0.1-10 wt. %, preferably 0.2-5 wt. %, like 1.0 wt. %; Ammonia, added as 25 wt. % solution, or any other base: 0-5 wt. %, preferably 0.05-0.50 wt. %, more preferably 0.10-0.30% like 0.20%, the exact amount determined to adjust the pH to: 6-10, preferably 7.0-9.0 more preferably to 8; To which may also be added: Antifoam: 0.1-10 wt. %, preferably 0.2-5 wt. %, like 0.3 wt. %; Antioxidant: 0.1-10 wt. %, preferably 0.2-5 wt. %, like 0.7 wt. %; Biocide, such as fungicide or bactericide: 0-0.5 wt. %, preferably 0-0.1 wt. % such as 0.06 wt. %; Water: to adjust the viscosity to the desired value: preferably less than 20 wt. %; Viscosity modifier: to adjust the viscosity to the desired value: 0-5 wt. %, preferably 0-2 wt. %, like 0 wt. %. A resin is typically a solid or highly viscous substance of plant or synthetic origin that is typically convertible into polymers. Resins are usually mixtures of organic compounds. Most plant resins are considered to be composed of terpenes, such as alpha-pinene, beta-pinene, delta-3 carene, and sab-inene, in particular monocyclic terpenes, such as limonene and terpinolene, and smaller amounts of the tricyclic sesquiterpenes, such as longifolene, caryophyllene, and delta-ca-dinene. Some resins also contain a high proportion of resin acids. Rosins on the other hand are less volatile and consist of diterpenes among other compounds.

In a second aspect the present invention relates to a method of applying an adhesive according to the invention, comprising providing the adhesive, providing a substrate, wherein the substrate is selected from an open structure substrate, in particular from a foam, a non-woven material, and combinations thereof, and applying the adhesive to the substrate by using a spray system, a roller system, or a roller, or a roll coater.

In a third aspect the present invention relates to a product comprising an adhesive according to the invention, wherein the product is selected from a mattresses, upholstery, and combinations thereof.

In a fourth aspect the present invention relates to a use of an adhesive according to the invention, for one or more of obtaining a recovery after 5 days of >75%, in particular >90%, and substantially no deformation of the open structure substrate to which it is applied, in particular for a roll-pack process, more in particular a mattress roll-pack process.

The present adhesive is an aqueous dispersion, comprising water, a natural rubber, and at least one second dispersion. In addition, thereto it comprises at least one resin, such as at least one acidic resin. A resin is considered to relate to a solid-like or highly viscous substance which may be of plant or synthetic origin. It may be converted into polymers. Resins are typically mixtures of organic compounds. Most plant resins comprise terpenes. Some resins also contain a high proportion of resin acids. Rosins are less volatile, and may consist of diterpenes among other compounds. A rosin is typically a solidified resin from which the volatile terpenes have been removed, such as by distillation. Typically a rosin is a transparent or trans-lucent mass, with a vitreous fracture and a faintly yellow or brown colour, non-odorous or having only a slight turpentine odour and taste. A rosin may be obtained from pines and some other plants, mostly conifers. An acidic resin is used to lower the pH of the aqueous first dispersion to 6-11. Further ingredients of the present adhesive relate to at least one. surfactant, and optionally antifoam, antioxidant, biocide, and viscosity modifier. The present invention in particular relates to a water-based adhesive for a roller or roller system comprising 5-95 wt. % of an aqueous first dispersion, preferably 10-50 wt. %, more preferably 15-45 wt. %, even more in particular 25-30 wt. %, wherein the dispersion comprises a natural rubber, in particular a natural latex rubber, and 0-75 wt. % of a second component selected from polychloroprene dispersions, poly-urethane dispersion, poly-acrylate dispersions, styrene-butadiene-styrene copolymer dispersions, nitrile-butadiene rubber dispersions, polyvinyl butyral dispersions, styrene-butadiene rubber dispersions, poly ethylene vinyl acetate dispersions, poly vinyl acetate dispersions, and combinations thereof, in particular a second component selected from a poly-acrylate dispersion, and a polychloroprene dispersion, the dispersion comprising 30-80 wt. % solids, in particular 35-70 wt. % solids, more in particular 40-60 wt. % solids, further comprising 5-75 wt. % of at least one resin, such as an acidic resin, preferably 20-60 wt. %, more preferably 25-55 wt. %, even more preferably 33-50 wt. %, further comprising 0.1-10 wt. % of at least one surfactant, preferably 0.2-5 wt. %, such as 1.5-3 wt. %, and wherein the dispersion has a pH of 3.5-11, in particular 6.5-9, more in particular 7-8, and further comprising 0-35 wt. % water, in particular 7-32 wt. % water, more in particular 10-25 wt. % water, further comprising 0-10 wt. % antifoam, further comprising 0-10 wt. % antioxidant, further comprising 0-1 wt. % biocide, further comprising 0-5 wt. % viscosity modifier, wherein all weight percentages are based on a total weight of the respective first and second component.

In a second aspect the present invention relates to a method of applying an adhesive according to the invention, comprising providing the adhesive, providing a foam, and applying the adhesive to the foam by using a spray system, a roller system, or a roller, or a roller coater.

In a third aspect the present invention relates to a product comprising an adhesive according to the invention, wherein the product is selected from a mattresses, upholstery, and combinations thereof.

In a fourth aspect the present invention relates to a use of an adhesive according to the invention, for one or more of obtaining a recovery after 5 hours of >80%, a recovery after 5 days of >85%, in particular >90%, for a roll-pack process, in particular for a mattress roll-pack process. Thereby the present invention provides a solution to one or more of the above mentioned problems.

Advantages of the present description are detailed throughout the description. The teachings and examples of the present invention may be combined into a further not specifi-cally disclosed exemplary embodiment.

### DETAILED DESCRIPTION OF THE INVENTION

In a first aspect the invention relates to an adhesive. The adhesive, based on solid percentage in final adhesive may comprise LATZ 5-95 wt. %, preferably 10-50 wt. %, more preferably 15-40 wt. %, like 25 wt. %; Polyacrylate/resin mixture, comprising of, based on final mixture, Polyacrylate dispersion: 0-75 wt. %, preferably 10-50 wt. %, more preferably 15-40 wt. % like 25 wt. %; Glycerol ester of rosin: 5-75 wt. %, preferably 20-60 wt. %, more preferably 45-55 wt. % like 50 wt. %; Polychloroprene dispersion: 0-10 wt. %, Preferably 0-5 wt. %, like 0 wt. %; Surfactant: 0-10 wt. %, preferably 0.1-5 wt. %, like 1.0 wt. %; Ammonia. added as 25 wt. % solution. or any other base: 0-5 wt. %, preferably 0.05-0.50 wt. %, more preferably 0.10-0.30 wt. % like 0.20 wt. %; wherein an exact amount is determined to adjust the pH to: 6-11, preferably 7.0-9.0 more preferably to about 8; to which may also be added: Antifoam: 0.1-10 wt. %, preferably 0.2-5 wt. %, like 0.3 wt. %; Antioxidant: 0.1-10 wt. %, preferably 0.2-5 wt. %, like 0.7 wt. %; Biocide. such as fungicide or bactericide: 0-0.5 wt. %, preferably 0-0.1 wt. % such as 0.06 wt. %; Water: to adjust the viscosity to the desired value: preferably less than 20 wt. %; Viscosity modifier: to adjust the viscosity to the desired value: 0-5 wt. %, preferably 0-2 wt. %, like 0 wt. %.

In an exemplary embodiment of the present adhesive the resin, in particular the acidic resin, is selected from rosin resins, in particular from rosin esters, more in particular from glycerol rosin esters, from acidic resins, in particular with an acid value (neutralization number; acid number) of 60-100 (EN 14104), more in particular with an acid value of 70-90, from neutralized resins, in particular with an acid value (also referred to as neutralization number or acid number) of 40-80 (EN 14104), more in particular with an acid value of 50-70, and combinations thereof.

In an exemplary embodiment the present adhesive comprises 0.1-10 wt. %, antifoam, preferably 0.15-5 wt. %, like 0.2-0.3 wt. %.

In an exemplary embodiment the present adhesive comprises 0.1-10 wt. % antioxidant, preferably 0.2-5 wt. %, like 0.9-1.3 wt. %.

In an exemplary embodiment the present adhesive comprises 0.005-1 wt. % biocide, such as fungicide or bactericide, preferably 0.01-0.1 wt. % such as 0.02-0.03 wt. %, and/or 0.001-5 wt. % viscosity modifier, preferably 0.01-2 wt. %, like 00.02-0.05 wt. %.

In an exemplary embodiment the present adhesive comprises 0.0-5 wt. % second surfactant, preferably 0.1-3 wt. %, such as 0.3-1.5 wt. %, 0-40 wt. % filler, preferably 0.1-10 wt. %, such as 0.2-5 wt. %, 0-5 wt. % of an adhesion promotor, preferably 0.1-3 wt. %, such as 0.3-1.5 wt. %, 0-30 wt. % of a tackifier, preferably 0.5-20 wt. %, such as 3-15 wt. %, 0-5 wt. % of at least one further additive, preferably 0.1-3 wt. %, such as 0.3-1.5 wt. %. A tackifier is a chemical compound which may be used in formulating adhesives to increase tack, the stickiness of the surface of the adhesive. Tackifiers typically have a low molecular weight, and glass transi-tion and softening temperature above room temperature, providing them with suitable viscoe-lastic properties. Tackifiers frequently represent most of both weight percentage and cost of hot melt adhesives and pressure-sensitive adhesives. In hot melt adhesives they can comprise up to about 40% of total mass. Such is very different from the present application. Tackifiers can be resins (e.g. rosins and their derivates, terpenes and modified terpenes, aliphatic, cyclo-aliphatic and aromatic resins etc.).

In an exemplary embodiment of the present method the adhesive is applied in the production of a mattress, or an upholstery.

In an exemplary embodiment of the present method after applying the adhesive, the applied adhesive is dried, in particular forced dried, wherein drying is selected from subjecting to infrared light, increasing the temperature of the applied adhesive, such as in a tunnel or in an oven, providing an air-flow over the applied adhesive, and combinations thereof.

The invention is further detailed by the accompanying figures and examples, which are exemplary and explanatory of nature and are not limiting the scope of the invention. To the person skilled in the art it may be clear that many variants, being obvious or not, may be con-ceivable falling within the scope of protection, defined by the present claims.

### FIGURES

In FIG. 1. a schematic representation of gap recovery is given.

FIGS. 2-6 show photos of experimental procedural steps.

### EXAMPLES

The following formulations were made [TABLE 1](AV=Acid Value):

| | F1 | F2 | F3 | F4 | F5 | F6 |
|---|---|---|---|---|---|---|
| Latex LATZ Low ammonia | 100.00 | 90.00 | 80.00 | 70.00 | 60.00 | 50.00 |
| Rosin ester blend. | — | 10.00 | 20.00 | 30.00 | 40.00 | 50.00 |
| AV= 70-90 | | | | | | |
| Viscosity modifier | 5.60 | 5.04 | 4.48 | 3.92 | 3.36 | 2.80 |
| Anionic surfactant | 2.80 | 2.98 | 3.16 | 3.34 | 3.52 | 3.70 |
| Demi-water | 10.20 | 18.15 | 26.05 | 34.00 | 41.80 | 49.70 |
| Solids content | 54.03 | 54.00 | 53.99 | 53.97 | 54.00 | 53.99 |
| pH | 9.5 | 8.8 | 8.5 | 8.3 | 8.1 | 8.0 |

Amounts added in gram, additional water to compensate for solid resin and to maintain solids content.

From the preparation data in table 1 can be seen that, due to the changing ratio of LATZ:Resin, by increasing the resin and water (necessary to maintain solid content) and de-creasing the viscosity modifier, the viscosity and pH drop.

Two pieces of foam were adhered and immediately tightly rolled as model for a roll pack process. After drying for the time stated in the table 2 the pack was unrolled. To establish the performance of these formulations in a roll pack application the increased hight was measured of a bonded foam specimen when one side was levelled with the surface (drawing required). Also the recovery was tested. By recovery we mean the layer thickness of the bonded specimen after compression compared in ratio to the original thickness.

The following results were obtained [TABLE 2]:

| | | bonding roll pack | recovery | gap | recovery | gap |
|---|---|---|---|---|---|---|
| | | IR activation 10 | after 5 | after 5 | after 5 | after 5 |
| Sample | Formulation | seconds | hours | hours | days | days |
| S1 | F1 | 100% foam tear | 71.67 | 5.70 | 75.00 | 3.10 |
| S2 | F2 | 100% foam tear | 83.33 | 4.80 | 90.00 | 2.80 |
| S3 | F3 | 100% foam tear | 83.33 | 2.50 | 85.00 | 0.70 |
| S4 | F4 | 100% foam tear | 88.33 | 1.60 | 95.00 | 1.20 |
| S5 | F5 | 100% foam tear | 81.67 | 0.30 | 93.33 | 0.00 |
| S6 | F6 | 100% foam tear | 91.67 | t.b.d. | 93.33 | t.b.d. |

Table 2. S1 was bonded using adhesive F1, etc.

From table 2 it can be seen that all formulations F1 to F6 perform well as adhesive, in all cases when the bonded specimen S1-S6 are teared from each other the foam tears for 100%. After 5 hours the recovery of pure LATZ is much lower compared to the specimen bonded with a resin containing LATZ and by increasing the resin the recovery also increases. Similar results were obtained after 5 days. The undesired gap shows an opposite value change: the higher the resin the lower the gap, both again after 5 hours as well as measured after 5 days.

The following formulations were made [TABLE 3]:

| | F7 | F8 | F9 | F10 | F11 | F12 |
|---|---|---|---|---|---|---|
| Latex LATZ | 31.03 | 28.06 | 25.07 | 22.04 | 18.99 | 15.91 |
| Rosin ester blend (Acid Value 70-90) | 37.86 | 34.24 | 30.59 | 26.89 | 23.16 | 19.40 |
| Surfactant | 2.80 | 2.53 | 2.26 | 1.99 | 1.71 | 1.43 |
| Viscosity modifier | 2.12 | 1.92 | 1.71 | 1.51 | 1.30 | 1.09 |
| Demi water | 26.19 | 21.84 | 17.43 | 13.01 | 8.52 | 3.05 |
| Polyacrylate dispersion | — | 11.41 | 22.94 | 34.57 | 46.32 | 58.21 |
| Solid content (%) | 59.69 | 59.69 | 59.70 | 59.68 | 59.68 | 59.70 |
| pH | 7.74 | 7.51 | 7.33 | 6.99 | 6.83 | 6.72 |
| Viscosity mPas | 840 | 625 | 525 | 590 | 605 | 815 |

Amounts added in gram, additional water to compensate for solid resin and to maintain solids content.

Two pieces of foam were adhered using the formulation in table 3 and immediately tightly rolled as model for a roll pack process. After drying for the time stated in the table 4 (five hours or 5 days) the pack was unrolled. To establish the performance of these formulations in a roll pack application the increased hight was measured of a bonded foam specimen when one side was levelled with the surface (drawing required). Also the recovery was tested. By recovery we mean the layer thickness of the bonded specimen after compression compared in ratio to the original thickness.

The compression strength was measured as follows:

### Definition

Compression strength: This is the strength of an adhesive in the early stage of mattress production. Therefore, the compression strength is the strength of an adhesive after the press.

### Requirements

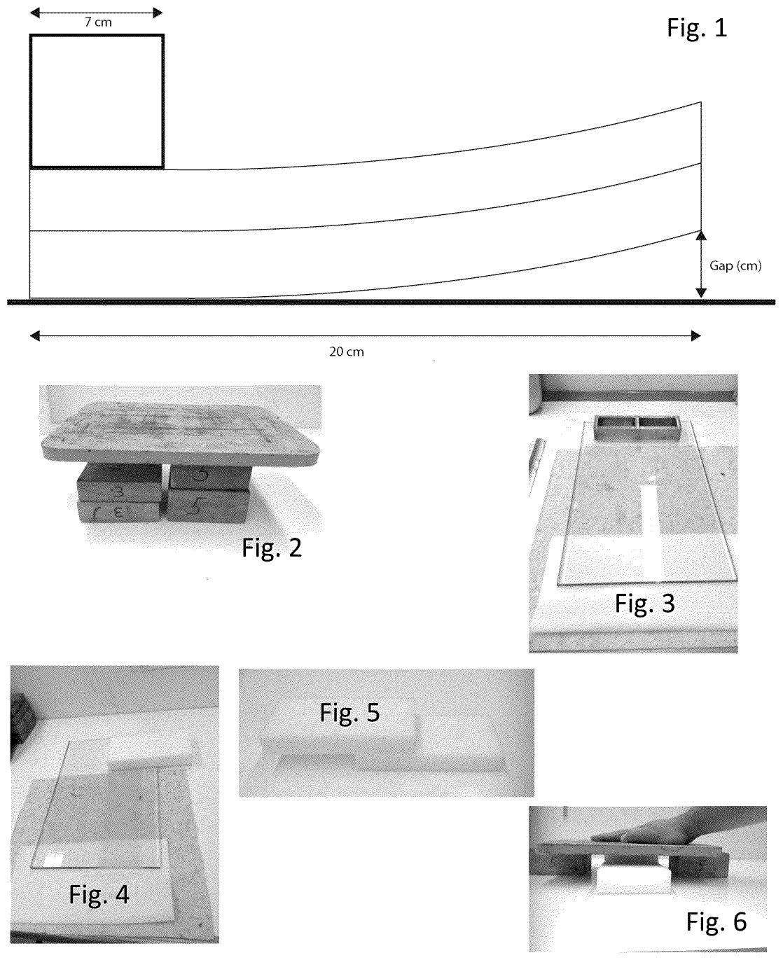

Foam samples with a dimension of 20*10*3 cm, foam type: VSI 9540, density 40 kg/m3 Glass plate
Blade of 250 μm eventually spraying equipment with accessories
IR-radiation equipment
Tensile test machine
Pressing device, board, two wooden blocks of 3 cm thickness (FIG. 2)
Scale with a accuracy of 0.01 g
Stopwatch

### Procedure

Apply an adhesive film, 250 μm, with the doctor blade on the glass plate. (FIG. 3) Bond two pieces of foam by glass plate transfer method (FIG. 4) by dipping the foam part in the adhesive film, press by hand. Weigh the foam part.
Typically 100 g/m² is applied on one side.
Heat activate the adhesive by a chosen method such as IR-radiation for 15 s
Directly make a overlapped shear tension bond 8*10 cm (FIG. 5)
Press the foam sample 10 second, at a depth of 50%, using wooden blocks 3 cm (FIG. 6)
Start the stopwatch and ensure that the tensile test starts 1 minute after the bond is made.
Clamp the foam sample in the tensile machine.
Perform the tensile test for at least three times.

The following results were obtained [TABLE 4]:

| | | | recovery | gap | recovery | gap | |
|---|---|---|---|---|---|---|---|
| | | bonding roll pack | after 5 | after 5 | after 5 | after 5 | Compression |
| | | IR activation 10 | hours | hours | days | days | Strength |
| Sample | Formulation | seconds | % | cm | % | cm | N/m² |
| S7 | F7 | 100% foam tear | 88.33 | n.m. | 95.00 | n.m. | 0.19 |
| S8 | F8 | 100% foam tear | 93.33 | 1.60 | 95.00 | 1.00 | 0.32 |
| S9 | F9 | 100% foam tear | 90.00 | 1.30 | 93.33 | 0.80 | 0.36 |
| S10 | F10 | 100% foam tear | 91.67 | 1.40 | 96.67 | 0.70 | 0.35 |
| S11 | F11 | 100% foam tear | 93.33 | 1.50 | 93.33 | 0.70 | 0.39 |
| S12 | F12 | 100% foam tear | 91.67 | 1.60 | 96.67 | 0.90 | 0.51 |

Table 4. S7 was bonded using adhesive F7, etc.; n.m.=not measured

From these results it can be seen that the addition of an polyacrylate has a positive effect on some aspects of the adhesives such as compression strength and does not negatively influ-ence the key aspects of the invention.

It should be appreciated that for commercial application it may be preferable to use one or more variations of the present system, which would similar be to the ones disclosed in the present application.

1. A water-based adhesive for a selection from a roller and roller system and roll coater comprising
a dispersion, the dispersion comprising 5-95 wt. % of an aqueous first dispersion, wherein the first dispersion comprises a natural rubber, the natural rubber dispersion comprising 30-80 wt. % solids, and 0-75 wt. % of a second dispersion selected from polychloroprene dispersions, poly-urethane dispersion, poly-acrylate dispersions, styrene-butadiene-styrene copolymer dispersions, nitrile-butadiene rubber dispersions, polyvinyl butyral dispersions, styrene-butadiene rubber dispersions, poly ethylene vinyl acetate dispersions, poly vinyl acetate dispersions, polyvinyl alcohols, and combinations thereof, the second dispersion comprising 30-80 wt. % solids, further comprising 5-95 wt. % of at least one resin, further comprising 0-10 wt. % of at least one surfactant, selected from an anionic surfactant, a cationic surfactant, and a non-ionic surfactant, and wherein the dispersion has a pH of 3.5-11, and further comprising 0-35 wt. % additional water further comprising 0-10 wt. % antifoam, further comprising 0-10 wt. % antioxidant, further comprising 0-1 wt. % biocide, further comprising 0-5 wt. % viscosity modifier,
wherein all weight percentages are based on a total weight of the adhesive.

2. The adhesive according to claim 1, wherein the resin is selected from rosin resins, from acidic resins, from neutralized resins, and combinations thereof.

3. The adhesive according to claim 1, wherein the aqueous first dispersion comprises 5-95 wt. % at least one natural rubber, and a cationic stabilized natural latex rubber dispersion.

4. The adhesive according to claim 1, comprising a selection from 10-50 wt. % of the second dispersion, and
comprising 0.1-10 wt. %, antifoam, and
comprising 0.1-10 wt. % antioxidant.

5. The adhesive according to claim 1, comprising a selection from 0.005-1 wt. % biocide, and 0.001-5 wt. % viscosity modifier.

6. The adhesive according to claim 1, comprising
0.0-5 wt. % second surfactant,
0-40 wt. % filler,
0-30 wt. % of a tackifier, and
0-5 wt. % of at least one further additive.

7. A method of applying an adhesive according to claim 1, comprising
providing the adhesive,
providing a substrate, wherein the substrate is selected from an open structure substrate, a non-woven material, and combinations thereof, and
applying the adhesive to the substrate by using a selection from a roller system and a roller and a roll coater.

8. The method according to claim 7, wherein the adhesive is applied in the production selected from a mattress, and an upholstery.

9. The method according to claim 7, wherein, after applying the adhesive, the applied adhesive is dried, wherein drying is selected from subjecting to infrared light, increasing the temperature of the applied adhesive, providing an air-flow over the applied adhesive, and combinations thereof.

10. A product comprising an adhesive according to claim 1, wherein the product is selected from a mattresses, upholstery, and combinations thereof.

11. A use of an adhesive according to claim 1, for at least one of obtaining a recovery after 5 days of >85%, wherein recovery is the ratio of the layer thickness of the bonded specimen after compression compared to the original thickness, and substantially no deformation of the open structure substrate to which it is applied.

12. The water-based adhesive according to claim 1, wherein the second dispersion is selected from a poly-acrylate dispersion and a polychloroprene dispersion.

13. The adhesive according to claim 2, wherein the rosin resin is a rosin ester, the acidic resins with an acid value of 60-100 (EN 14104), the neutralized resins with an acid value (neutralization number; acid number) of 40-80 (EN 14104).

14. The adhesive according to claim 3 wherein the at least one natural rubber is at least one natural latex rubber.

15. The adhesive according to claim 6, wherein the filler is selected from talc, chalk, titanium dioxide, and combinations thereof.

16. A use of an adhesive according to claim 11, wherein the adhesive is applied to a roll pack process.
